(19) United States
(12) Patent Application Publication
(10) Pub. No.: US 2019/0224894 A1
(43) Pub. Date: Jul. 25, 2019

(54) MOLDING APPARATUS AND MOLDING METHOD FOR OVERMOLDING A SHEET

(71) Applicant: TOYOTA MOTOR EUROPE, Brussels (BE)

(72) Inventors: Martin KERSCHBAUM, Brussels (BE); Julien TACHON, Brussels (BE)

(73) Assignee: TOYOTA MOTOR EUROPE, Brussels (BE)

(21) Appl. No.: 16/314,309

(22) PCT Filed: Dec. 13, 2016
(86) PCT No.: PCT/EP2016/080844

§ 371 Date: Dec. 28, 2018

(51) Int. Cl. B29C 45/14

(52) U.S. Cl. CPC B29C 45/14221; B29C 45/14786

(57) ABSTRACT

A molding apparatus and a molding method for molding a part including an overmolded sheet, the molding apparatus including a mold including a first mold tool and a second mold tool configured to face each other and to move in relation to each other so as to define a gap between them for molding therein a part including an overmolded sheet, and at least one preforming element, distinct from the second mold tool, having a shape, or being configured to take a shape, complementary to that of a portion of the first mold tool, and configured to preform the sheet onto the portion of the first mold tool.

### TECHNICAL FIELD

The present disclosure relates to a molding apparatus and a molding method for molding a part comprising an overmolded sheet.

Such a molding apparatus or method is particularly useful when molding parts having a complex geometry, that is to say when the sheet has to be preformed in a complex way. Such a molding apparatus or method can be used in any technical field for molding parts of any type. For example, it can be used in the automotive industry for manufacturing automobile parts.

### TECHNOLOGICAL BACKGROUND

Nowadays, an increasing number of automobile parts are produced in composite materials, such composite materials being light while having a high strength. As a result, manufacturing methods have been devised wherein an organo sheet is set in a molding apparatus and overmolded with an organic matrix which is then solidified.

Nevertheless, the preforming step of such manufacturing methods may be tricky when the geometry of the part to be produced is complex. Indeed, in some cases, it may be necessary to drape the organo sheet in one or several cavities of the molding apparatus. And yet, it has been experienced that it was difficult to set the organo sheet in the correct position in such a cavity; besides, draping an organo sheet in such a cavity often leads to the appearance of wrinkles in the sheet which can lead to defects in the final part.

As a result, several molding apparatuses implementing different preforming methods have been devised in order to ease the draping of the sheets in such complex cases.

In a very simple way, it is possible to use gravity to drape a sheet on a generally horizontal mold tool. Nevertheless, the draping force induced by gravity is limited and cannot be used for complex geometries. Furthermore, such a method requires a vertical closing molding apparatus, which is not standard.

Another option is to use the second mold tool, that is to say the second half of the mold, to preform the sheet on the first mold tool, that is to say the first half of the mold, when closing the molding apparatus. Nevertheless, it is very difficult to achieve a wrinkle free draping when using such a method. Sheet strainers configured to draw tight the sheet may be used to help reduce the appearance of wrinkles during the draping; nevertheless, the integration and adjustment of such sheet strainers are particularly difficult.

Another option yet is to use preforming rollers rolling over the sheet to press it against the first mold tool. Nevertheless, such rollers apply pressure only locally and temporarily: hence, the sheet may detach from the tool surface and lose its shape once the rollers leave the area. Furthermore, because of their given diameter, the rollers are inefficient in the concave area whose radius is inferior to the rollers' radius. Besides, such rollers need complex kinematics and control technologies which have to be devised anew for each part.

As a result, there is a real need for a molding apparatus and a molding method for molding a part comprising an overmolded sheet which are, at least partly, devoid of the drawbacks of the above mentioned known methods.

### SUMMARY OF THE INVENTION

The present disclosure relates to a molding apparatus, comprising a mold including a first mold tool and a second mold tool configured to face each other and to move in relation to each other so as to define a gap between them for molding therein a part comprising an overmolded sheet, and at least one preforming element, distinct from the second mold tool, having a shape, or being configured to take a shape, complementary to that of a portion of the first mold tool, and configured to preform said sheet onto said portion of the first mold tool.

Thanks to such a preforming element, it is possible to efficiently drape the sheet onto the first mold tool. Indeed, since the preforming element matches the shape of the first mold tool, the whole surface of the preforming element applies pressure onto the sheet so as to press it against the first mold tool. Accordingly, the sheet is precisely preformed so as to matches the shape of the first mold tool, irrespective of the complexity of its geometry: for example, such a preforming element can accurately drape the sheet in a cavity of the first mold tool, whatever the size of the cavity. Besides, the sheet is firmly held by the preforming element so that it cannot detach from the first mold tool once draped onto it.

In addition, since the preforming element is distinct from the second mold tool, its size and position can be designed freely. Particularly, it is possible to design the preforming so that it contacts only a portion of the sheet. First, this reduces the heat dissipation through the preforming element so that the sheet remains sufficiently warm, and thus flexible, during the draping process. Then, thanks to such a configuration, some portions of the sheet keep their freedom of movement, which helps reducing the appearance of wrinkles or other defects.

In some embodiments, the frontal surface of at least a preforming element is strictly smaller than the frontal surface of the first mold tool. As explained, this helps reduce the heat dissipation and the appearance of wrinkles or other defects in the sheet.

In some embodiments, the frontal surface of the at least one preforming element is inferior to 20%, preferably 10%, of the frontal surface of the first mold tool.

In some embodiments, the at least one preforming element is plate-shaped, a length of the at least one preforming element being at least five times greater than its width. Such a plate shape enables to act on an important area of the sheet while having a small contact surface. Particularly, such plate-shaped preforming elements are all the more effective when used at least in couple: indeed, in such a configuration, the whole portion of the sheet located between two plate-shaped preforming elements is draw tight by the preforming elements and can therefore be precisely preformed without directly contacting the preforming elements.

In some embodiments, the at least one preforming element extends continuously from one end of the first mold tool to an opposite end of the first mold tool.

In some embodiments, the first mold tool comprises projections and/or recesses.

In some embodiments, the shape of the first mold tool is constant in the width direction.

In some embodiments, the molding apparatus comprises a plurality of preforming elements. As explained above, this enables to drape a large area of the sheet while limiting the contact surface with the preforming element.

In some embodiments, all the preforming elements are identical. Nevertheless, in other embodiments, some or all the preforming elements could be different.

In some embodiments, all preforming elements of the plurality of preforming elements extend in parallel along a longitudinal direction of the first mold tool at different levels in a width direction of the first mold tool. Such a configuration is particularly effective when the shape of the first mold tool is constant in the width direction.

In some embodiments, the at least one preforming element comprises a low heat-conductive material. It is preferably totally composed of low heat-conductive materials. Particularly, the heat conductivity of this or these material(s) may be inferior to 0.5 W/mK, preferably inferior to 0.05 W/mK. Hence, the heat dissipation from the sheet through the preforming element is even more reduced.

In some embodiments, the at least one preforming element is provided with a low heat-conductive coating. Particularly, the heat conductivity of coating may be inferior to 0.5 W/mK, preferably inferior to 0.05 W/mK. Hence, the heat dissipation from the sheet through the preforming element is even more reduced.

In some embodiments, the at least one preforming element comprises a low sticking material. It is preferably totally composed of low sticking materials. For example such a material can be PTFE (Polytetrafluorethylene). Hence, the melted matrix of the sheet is prevented from sticking to the preforming element when the preforming element is removed.

In some embodiments, the at least one preforming element is provided with a low sticking coating. For example, this coating may comprise PTFE (Polytetrafluorethylene). Hence, the melted matrix of the sheet is prevented from sticking to the preforming element when the preforming element is removed.

In some embodiments, the at least one preforming element comprises a plurality of segments movable in relation to each other. This enables to drape the sheet in a progressive way so as to avoid the appearance of defects such as wrinkles. Such a configuration is particularly useful when the first mold tool has important level differences: in such a case, for example, in a first stage, a first segment can drape the sheet on the top of a protrusion and, in a second stage, a second segment can move forward to drape the remainder of the sheet onto the flank of the protrusion down to the bottom of a cavity. These segments can be individually controlled; alternatively, they can be spring loaded so as to move together until a segment contacts the first mold tool.

In some embodiments, the frontal surface of the at least one preforming element is configured to self-adapt to the shape of the first mold tool. Thanks to such a configuration, the draping of the sheet is progressive and provides a flattening effect of the sheet, which helps reducing the appearance of defects such as wrinkles.

In some embodiments, the frontal surface of at least a preforming element is elastic.

In some embodiments, the at least one preforming element comprises a flexible frontal surface and a forming device configured to cause the frontal surface to take a predetermined shape. For instance, the flexible frontal surface is formed by a flexible band or a membrane.

In some embodiments, the forming device comprises a plurality of pins. The amount of pins and their distance to each other can freely and easily been modified to improve the local adaptivity of the flexible frontal surface.

In some embodiments, the pins are spring-loaded.

In some embodiments, the pins are actuated thanks to active actuators. For example, such actuators may be pneumatic actuators, hydraulic actuators or electric actuators.

In some embodiments, the at least one preforming element comprises an elastic material. It is preferably totally composed of elastic materials. Such an elastic material can be an elastomeric or a foam material.

In some embodiments, the at-rest shape of the frontal surface of at least a preforming element is planar.

In other embodiments, the at-rest shape of the frontal surface of the at least one preforming element is non-uniform. Particularly, the at-rest shape of frontal surface may comprise a recessed portion. Such a configuration enables to improve the contact timing with the sheet, preferably so as to drape the sheet in a progressive way from the inside to the outside of the sheet. Such improved contact timing helps reducing the appearance of defects such as wrinkles during the draping process.

In some embodiments, the first mold tool comprises at least a gripping device, preferably several gripping devices, configured to hold the sheet on the first mold tool. Such gripping devices may be needle grippers or vacuum grippers. These gripping devices enable to hold the sheet on the first mold tool once the sheet has been preformed and the preforming element has been retracted.

In some embodiments, at least a preforming element comprises at least a gripping device, preferably several gripping devices, configured to hold the sheet on the preforming element. Such gripping devices may be needle grippers or vacuum grippers. Thanks to these gripping devices, the preforming element can act as a manipulating device and pick up the sheet after the pre-heating stage and transfer it to the molding apparatus.

In some embodiments, the at least one preforming element is retractable so as to allow the closing of the mold.

In some embodiments, the first and second mold tools extend face to face, preferably substantially vertically.

In some embodiments, the first mold tool and/or the second mold tool are one-piece. Nevertheless, in other embodiments, the first mold tool and/or the second mold tool comprises several segments mobile in relation to each other.

In some embodiments, the first mold tool and/or the second mold tool comprises at least an injector configured to inject a matrix so as to surround the sheet.

In some embodiments, a preforming element is configured to contact the sheet at a point facing an injector of the first mold tool and/or the second mold tool. Preferably, the at least one preforming element is configured so that all the points of the sheet facing an injector of the first mold tool or the second mold tool are in contact with a preforming element during the draping process. Hence, the portions of sheet in contact with the preforming elements are locally cooled down and, thus, harden, which helps to keep the sheet in the right position and shape when the at least one preforming element is removed and the mold is closed. Furthermore, thanks to this cooling effect, these portions located in front of the injectors remain sufficiently cold when the hot melt matrix is injected to keep the sheet stable in the mold during the injection process.

In some embodiment, a gap is provided between the first mold tool and the second mold tool when the mold is closed.

In some embodiments, this gap is wider that the thickness of the sheet. Hence, a face of the sheet can be completely overmolded so that the structure of the sheet is completely hidden by the matrix, which may improve the aesthetic aspect of the final part.

The present disclosure also relates to a molding method, comprising the steps of: providing a mold including a first mold tool and a second mold tool configured to face each other and to move in relation to each other; placing a sheet onto the first mold tool; preforming the sheet by using a preforming element to push the sheet against a portion of the first mold tool, while the preforming element matches the shape of said portion of the first mold tool; maintaining the sheet on the first mold tool; removing the preforming element; closing the mold; injecting a matrix into the mold; solidifying the matrix.

This method may notably use a molding apparatus according to any of the above mentioned embodiments.

The above mentioned features and advantages, and others, will become apparent when reading the following detailed description of exemplary embodiments of the presented molding apparatus and molding method. This detailed description refers to the accompanying drawings.

### BRIEF DESCRIPTION OF THE DRAWINGS

The accompanying drawings are diagrammatic and seek above all to illustrate the principles of the invention.

In the drawings, from one figure to another, elements (or portions of an element) that are identical are given the same reference signs.

Furthermore, elements (or portions of an element) belonging to different exemplary embodiments but having an analogous function are given reference signs incremented by 100, 200, etc.

FIGS. 1A-1E illustrate, in section views, succeeding steps of a molding method using a first molding apparatus.

FIG. 2 illustrates the first molding apparatus in plan view along the arrow II of FIG. 1C.

FIGS. 3A-3F illustrate, in section views, succeeding steps of a molding method using a second molding apparatus.

FIGS. 4A-4C illustrate, in section views, succeeding steps of a molding method using a third molding apparatus.

FIGS. 5A-5C illustrate, in section views, succeeding steps of a molding method using a fourth molding apparatus.

FIGS. 6A-6C illustrate, in section views, succeeding steps of a molding method using a fifth molding apparatus.

### DETAILED DESCRIPTION OF EMBODIMENTS

In order to make the invention more concrete, exemplary embodiments of molding apparatuses and exemplary molding methods are described in detail below with reference to the accompanying drawings. It should be recalled that the invention is not limited to these examples.

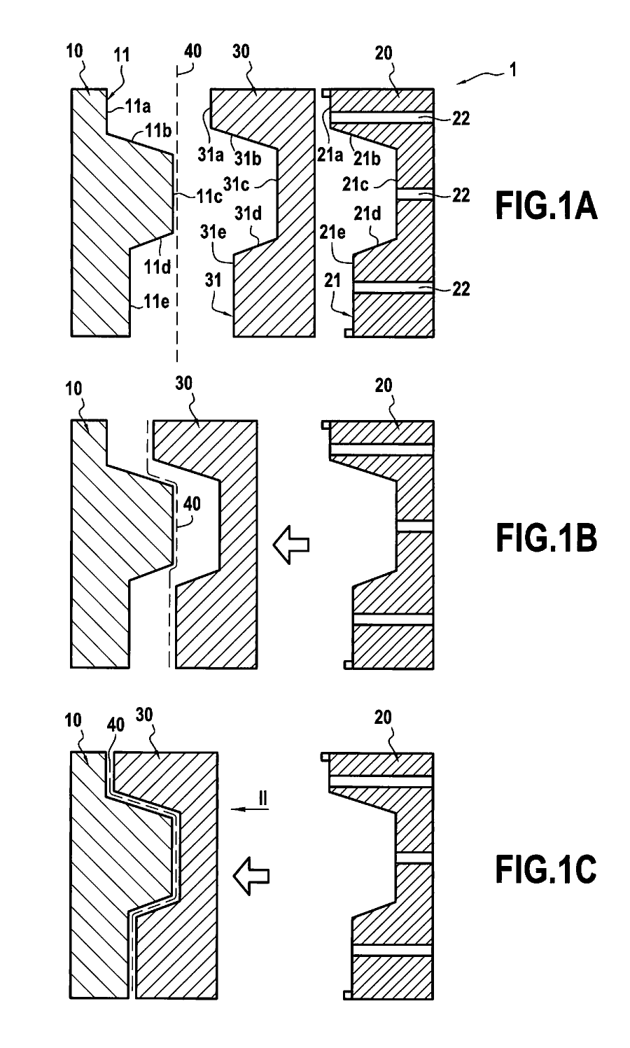

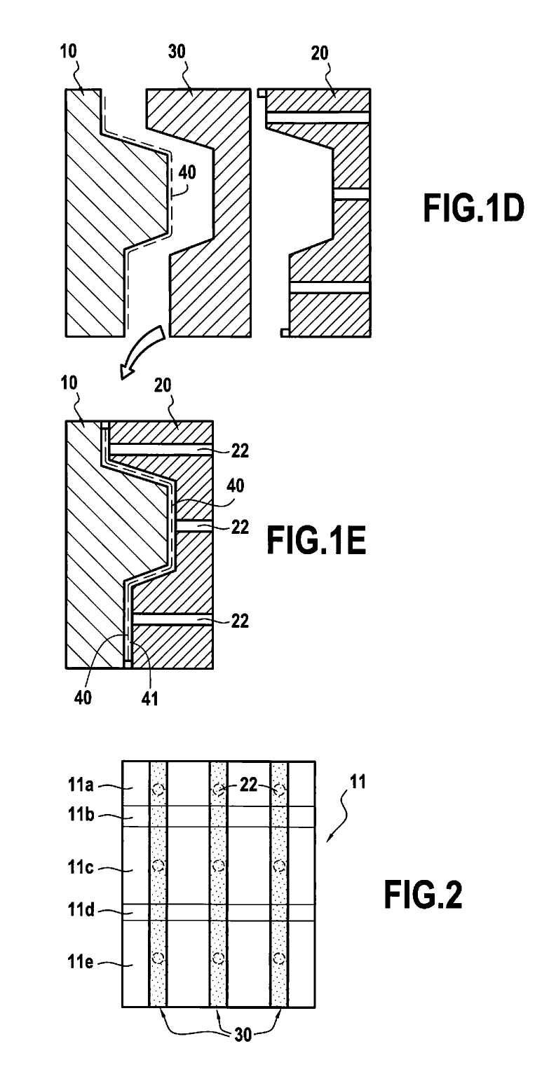

FIGS. 1A and 2 illustrate a first exemplary molding apparatus 1. This molding apparatus 1 comprises a mold including a first mold tool 10, and a second mold tool 20; it further comprises preforming elements 30.

The first mold tool 10, extending generally vertically, comprises a frontal surface 11 having several levels, projections and/or recesses. In the present example, the shape of the frontal surface 11 of the first mold tool 10 is invariant along the width direction but changes along the vertical direction: namely, it comprises a first flat portion 11a at a first recessed level, a first sloping portion 11b projecting toward the second mold tool 20, a second flat portion 11c at a second projected level, a second sloping portion 11d recessing backwards, and a third flat portion 11e at a third level located at an intermediate level between the first and the second levels.

Of course, the shape of the first mold tool 10 presented here is purely exemplary and diagrammatic: the first mold tool 10 may have any shape, simpler or more complicated, in accordance with the shape of the part to be molded.

The second mold tool 20, extending generally vertically, comprises a frontal surface 21, directed toward the frontal surface 11 of the first mold tool 10, whose shape is complementary to that of the frontal surface 11 of the first mold tool 10. As a result, in the present case, it comprises a first flat portion 21a at a first projected level, a first sloping portion 21b recessing backwards, a second flat portion 21c at a second recessed level, a second sloping portion 21d projecting towards the first mold tool 10, and a third flat portion 21e at a third level located at an intermediate level between the first and the second levels.

The second mold tool 20 is movable laterally in relation to the first mold tool 10. Furthermore, the second mold tool 20 comprises injectors 22 configured to inject a matrix in the gap defined by the first and second mold tool 10, 20 when the mold is closed. In the present example, as illustrated diagrammatically in FIG. 2, several injectors are provided in the first, the second and the third flat portions 21a, 21c, 21e of the second mold tool 20. Of course, in other example, the first mold tool 10 may comprise injectors in lieu or in addition to the injectors 22 of the second mold tool 20.

As regards the preforming elements 30, there are three of them in the present example, identical and extending generally vertically. Each preforming element 30 is a slender plate, having a reduced width (inferior to 2 cm in the present example) and extending from the upper end to the lower end of the first mold tool 10. It comprises a frontal surface 31, directed towards the zo frontal surface 11 of the first mold tool 10, whose shape is complementary to that of the frontal surface 11 of the first mold tool 10. As a result, in the present case, it comprises a first flat portion 31a at a first projected level, a first sloping portion 31b recessing backwards, a second flat portion 31c at a second recessed level, a second sloping portion 31d projecting towards the first mold tool 10, and a third flat portion 31e at a third level located at an intermediate level between the first and the second levels.

In the present example, the preforming elements 30 are made in a high temperature resistant plastic. They may also comprise a heating device and gripping devices such as vacuum grippers.

The preforming elements 30 are laterally movable in relation to the first mold tool 10 and are also retractable out of the space extending between both mold tools 10, 20 so as to enable the closing of the mold. They may for instance be attached, individually or collectively, to a manipulating device such as a robot, possibly the same manipulating device intended to hold the organo sheet 40 to be overmolded.

A first exemplary molding method using this first molding apparatus 1 will now be described with regard to FIG. 1A to 1E.

At the beginning of the method, as depicted in FIG. 1A, the mold composed of the first and second mold tools 10, 20 is opened and a pre-heated organo sheet 40 is inserted by a manipulating device in the space separating the first and second mold tools 10, 20. This organo sheet 40 is a textile fabric, generally made of glass or carbon fibers, impregnated by a hot matrix, generally a Polypropylene or Polyamide matrix. The organo sheet 40 is placed by the manipulating device so as to hang vertically against the most projected portion of the first mold tool 10, namely the second flat portion 11c in the present example.

As shown in FIG. 1B, the preforming elements 30 are inserted in the space between the organo sheet 40 and the second mold tool 20 and are progressively moved laterally toward the first mold tool 10. Accordingly, as the preforming elements 30 move towards the first mold tool 10, they push the organo sheet 40 and progressively drape it onto the frontal surface 11 of the first mold tool 10. As shown in FIG. 2, the preforming elements 30 are preferably located so as to contact the organo sheet 40 at every area facing a matrix injector 22 of the second mold tool 20.

As shown in FIG. 1C, once the preforming elements 30 have reached the first mold tool 10, the organo sheet 40 is firmly hold between the frontal surface 11 of the first mold tool 11 and the frontal surface 31 of each preforming element 30. The organo sheet 40 is therefore completely draped on the first mold tool 10 so that its shape matches the shape of the frontal surface 11 of the first mold tool 10. Furthermore, the first mold tool 10 may include gripping devices, such as vacuum grippers, enabling to hold the organo sheet 40 against the frontal surface 11 of the first mold tool 10. In addition, once the preforming of the organo sheet 40 is completed, the organo sheet 40 may be cooled down so as to harden it and freeze its shape.

Then, as shown in FIG. 1D, the preforming elements 30 are separated from the organo sheet 40 and retracted out of the space extending between the first and the second mold tools 10, 20.

Then, as shown in FIG. 1E, the second mold tool 20 is moved against the first mold tool 10 so as to close the mold around the organo sheet 40: the organo sheet 40 is therefore included in the gap 41 defined between the frontal surfaces 11, 21 of the first and second mold tools 10, 20. A Polypropylene matrix filled with long glass fibers is then injected in this gap 41 through the injectors 22 so as to overmold the organo sheet 40. The matrix is then solidified, the mold is opened and the part comprising the overmolded sheet is released.

In the present example, the width of the gap 41 substantially corresponds to the thickness of the organo sheet 40. Nonetheless, in other examples, this gap could be wider that the thickness of the organo sheet. In such a case, the preformed organo sheet 40 is hold against the first mold tool thanks to the gripper devices and a thicker layer of matrix fills the gap separating the organo sheet from the frontal surface 21 of the second mold tool 20: accordingly, in the final part obtained that way, a face of the organo sheet is totally hidden by a continuous layer of solidified matrix.

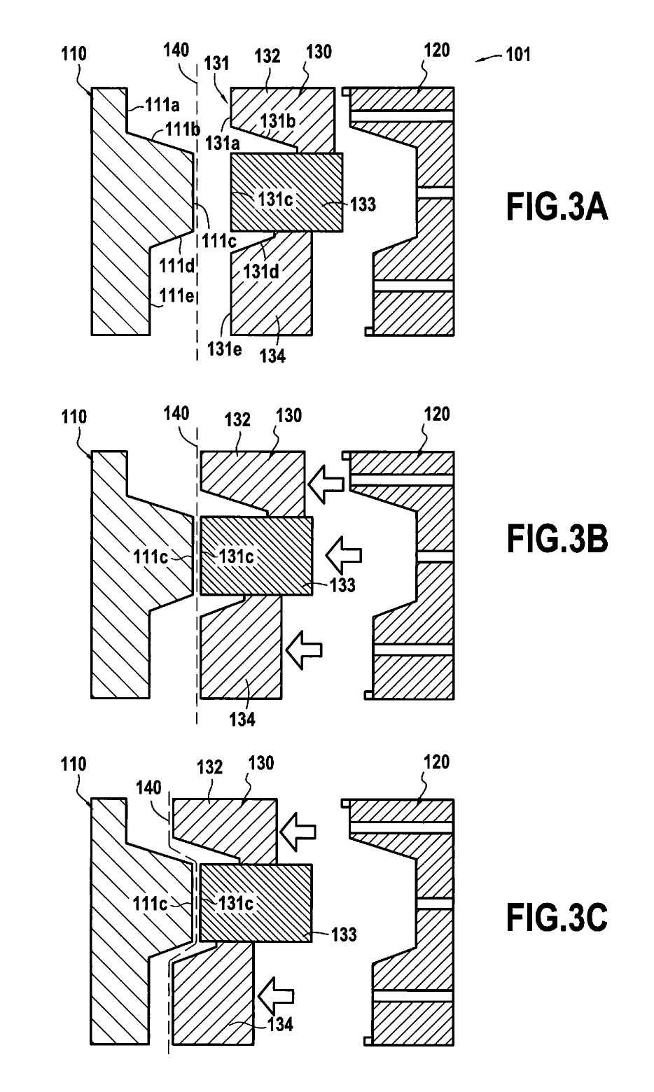

FIGS. 3A-3E illustrate a second exemplary molding apparatus and a second exemplary molding method using the same. Numerous aspects of these second molding apparatus and molding method are analogous to those of the first example and, thus, will not be presented in detail again. Only the specificities of this second example will be explained below.

In this second example, the molding apparatus 101 comprises a first mold tool 110 and a second mold tool 120 analogous to those of the first example. It also comprises several preforming elements 130. Contrary to the first example, each preforming element 130 comprises several segments 132, 133, 134 movable in relation to each other.

As in the first example, once fully spread out, the frontal surface 131 of each preforming element 130 matches the shape of the frontal surface 111 of the first mold tool 110: accordingly, the first segment 132 comprises the first flat portion 131a and the first sloping portion 131b, the second segment 132 comprises the second flat portion 131c and the third segment 133 comprises the second sloping portion 131d and the third flat portion 131e.

Initially, as shown in FIG. 3A, the organo sheet 140 is placed by the manipulating device so as to hang vertically against the most projected portion of the first mold tool 110, namely the second flat portion 111c.

As shown in FIG. 3B, the segments 132, 133, 134 of the preforming elements 130 are initially set so that the flat portions 131a, 131c and 131e extend along the same plane. Accordingly, when the preforming elements 130 are moved laterally toward the first mold tool 10, the second segment 133 of the preforming elements 130 first contacts the organo sheet 140 and, thus, firmly holds the organo sheet 140 against the second flat portion 111c of the first mold tool 110.

Then, as shown in FIG. 3C, the other segments 132, 134 of the preforming elements 130 continue to move towards the first mold tool 110, pushing the organo sheet 140 and progressively draping it onto the frontal surface 111 of the first mold tool 110. In this respect, since the central portion of the organo sheet 140 is hold between the second flat portion 111c of the first mold tool 110 and the central segment 133 of the preforming elements 130, the organo sheet 140 is more easily draped onto the sloping portions 111b and 111d of the first mold tool 110 by the side segments 132 and 134 of the preforming elements 130.

The remainder of the method is analogous to the first example.

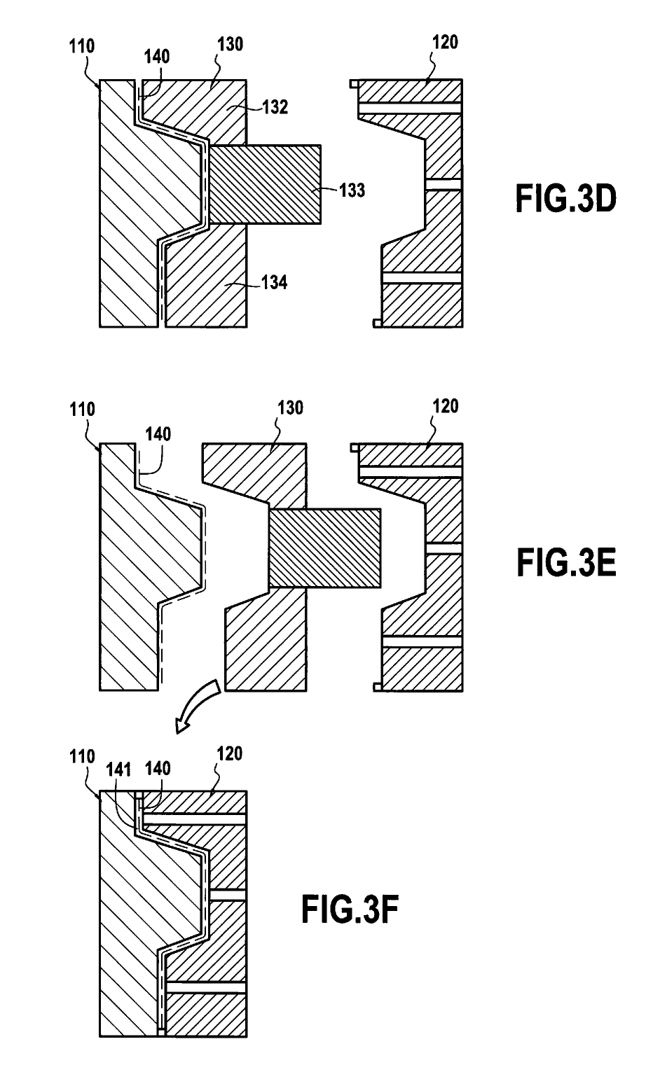

FIGS. 4A-4C illustrate a third exemplary molding apparatus and a third exemplary molding method using the same. Numerous aspects of these third molding apparatus and molding method are analogous to those of the first example and, thus, will not be presented in detail again. Only the specificities of this third example will be explained below.

In this third example, the molding apparatus 201 comprises a first mold tool 210 and a second mold tool analogous to those of the first example (for simplification purposes, the second mold tool is not depicted in these figures). It also comprises several preforming elements 230. Contrary to the first example, the frontal surface 231 of each preforming element 130 is flexible and deformable.

More precisely, each preforming element 230 comprises a membrane 235, defining its frontal surface 231, urged toward the first mold tool 210 by spring-loaded pins 236. These pins 236 are regularly provided along the whole height of the preforming elements 230. In this example, all the pins 236 have the same length and are provided with an identical spring: consequently, the frontal surface 231 of each preforming element 230 in its initial at-rest state is planar and vertical.

At the beginning of the molding method, as shown in FIG. 4A, the organo sheet 240 is placed by the manipulating device so as to hang vertically against the most projected portion of the first mold tool 210, namely the second flat portion 211c.

As shown in FIG. 4B, when the preforming elements 230 are moved laterally toward the first mold tool 210, the preforming elements 230 first contact the organo sheet 140 at the most projected portion of the first mold tool 210, that is to that the second flat portion 211c and, thus, firmly hold the organo sheet 240.

Then, the preforming elements 230 continue to move towards the first mold tool 210. As a result, the springs of the pins 236 of the preforming elements 230 begin to contract in the areas contacting the frontal surface 211 of the first mold tool 210 and the membrane 235 starts to become distorted to adapt oneself and match the shape of the first mold tool 210.

Accordingly, the preforming elements 230 push the organo sheet 240 and progressively drape it against the frontal surface 211 of the first mold tool 210. In this respect, since the draping is made progressively from the most projected portions of the first mold tool 210 to its most recessed portions, the draping is made in a more regular way, which helps to reduce the appearance of defects such as wrinkles.

The remainder of the method is analogous to the first example.

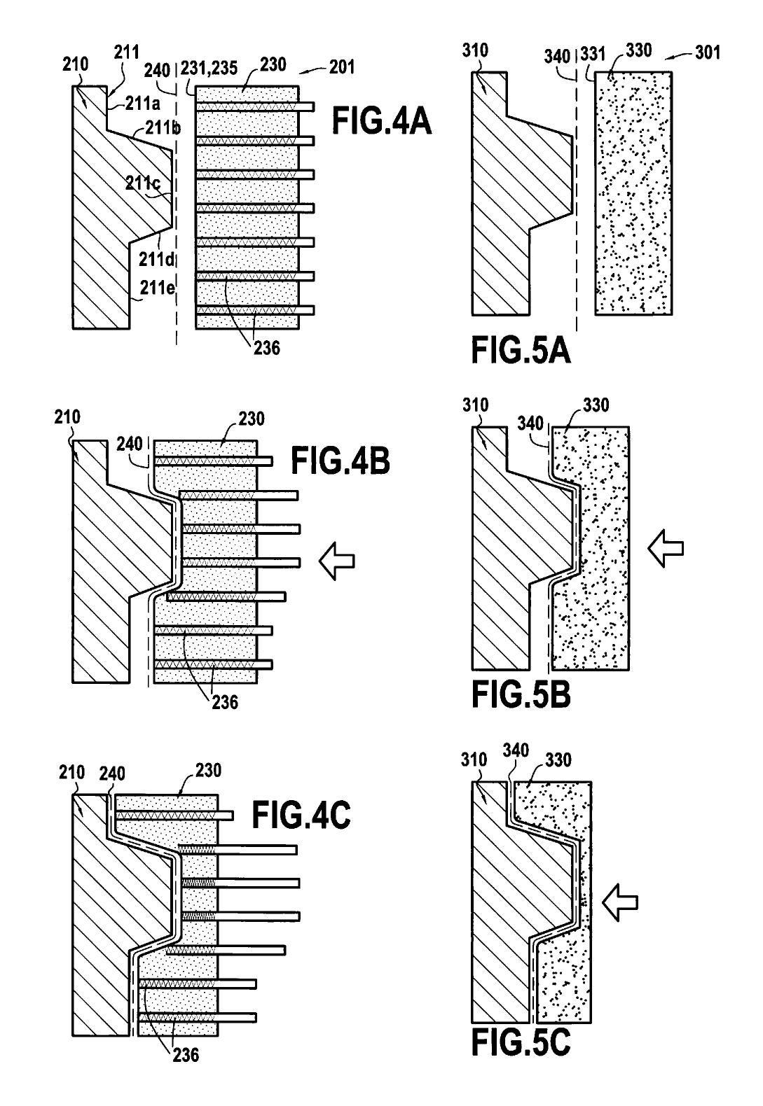

FIGS. 5A-5C illustrate a fourth exemplary molding apparatus and a fourth exemplary molding method using the same. Numerous aspects of these fourth molding apparatus and molding method are analogous to those of the first example and, thus, will not be presented in detail again. Only the specificities of this fourth example will be explained below.

In this fourth example, the molding apparatus 301 comprises a first mold tool 310 and a second mold tool analogous to those of the first example (for simplification purposes, the second mold tool is not depicted in these figures). It also comprises several preforming elements 330. Analogously to the third example, the frontal surface 331 of each preforming element 330 is flexible and deformable.

More precisely, in this example, each preforming element 330 is made of a foamed, elastic and flexible material and set so that the frontal surface 331 of each preforming element 330 in its initial at-rest state is planar and vertical.

The molding method is then analogous to the third example: the preforming elements 330 first contact the organo sheet 340 at the most projected portion of the first mold tool 310, that is to say the second flat portion 311c, then become distorted to adapt themselves and match the shape of the first mold tool 310 so as to progressively drape the organo sheet 340 onto the frontal surface 311 of the first mold tool 310.

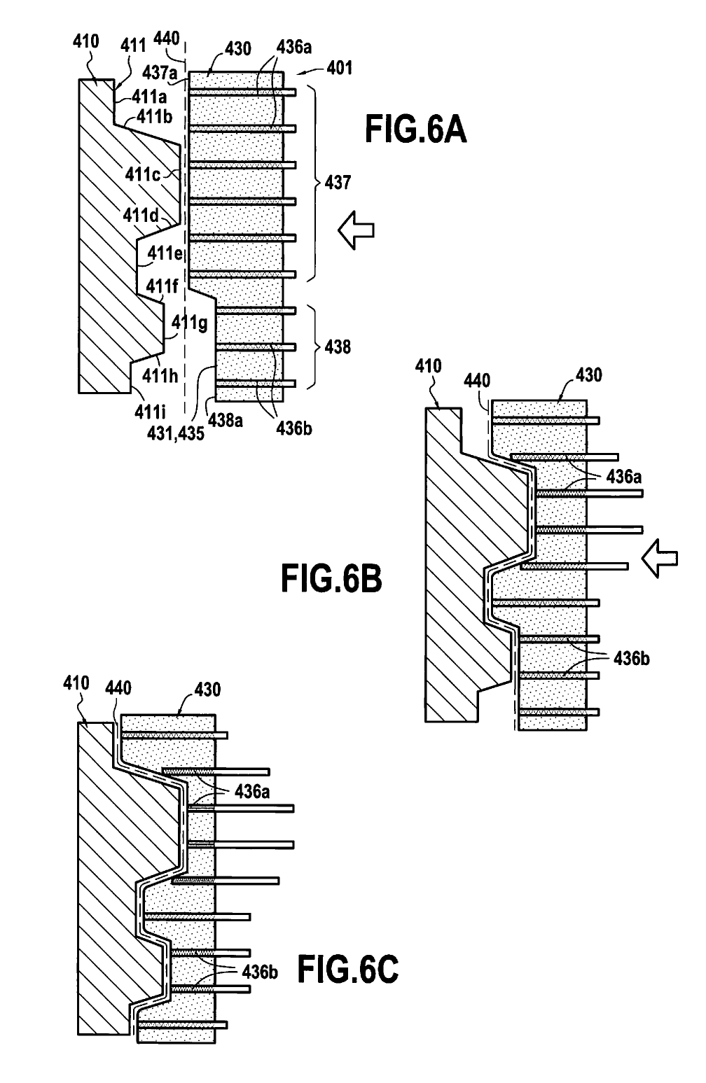

FIGS. 6A-6C illustrate a fifth exemplary molding apparatus and a fifth exemplary molding method using the same. Numerous aspects of these fifth molding apparatus and molding method are analogous to those of the first example and, thus, will not be presented in detail again. Only the specificities of this fifth example will be explained below.

In this fifth example, the molding apparatus 401 comprises a first mold tool 410 and a second mold tool (for simplification purposes, the second mold tool is not depicted in these figures). It also comprises several preforming elements 430.

In this example, the geometry of the first mold tool 410 is a little more complex than that of the first example. Particularly, in addition to the first, second and third flat portions 411a, 411c, 411e, linked by the sloping portions 411b, 411d, the frontal surface 411 of the first mold tool 410 further includes, below the third flat portion 411e, a fourth flat portion 411g, at a level intermediate between the levels of the second and third flat portions 411c, 411e, and a fifth flat portion 411i, at a level intermediate between the levels of the first and third flat portions 411a, 411e. Sloping portions 411f and 411h connect the third flat portion 411e with the fourth flat portion 411g and the fourth flat portion 411g with the fifth flat portion 411i, respectively.

Analogously to the third example, the frontal surface 431 of each preforming element 430 is flexible and deformable thanks to a membrane 435 urged toward the first mold tool 410 by spring-loaded pins. However, in order to ease the draping of the organo sheet 440 considering the increased shape complexity of the first mold tool 410, the initial at-rest shape of the preforming elements 430 is not fully planar : it comprises a first area 437, having pins 436a with a first length, so that the membrane 435 extends initially, in the at-rest state, along a first vertical plane 437a and a second area 438, having pins 436b with a second length shorter than the first length, so that the membrane 435 extends initially, in the at-rest state, along a second vertical plane 438a recessed vis-à-vis the first plane 437a. The second area 438 is set so as to face the fourth and fifth flat portions 411g, 411i of the first mold tool 410. Furthermore, the level difference between the first and second planes 437a, 438a is configured to be substantially equal to the level difference between the fourth and the third flat portions 411g, 411e of the first mold tool 410.

At the beginning of the molding method, as shown in FIG. 6A, the organo sheet 440 is placed by the manipulating device so as to hang vertically against the most projected portion of the first mold tool 410, namely the second flat portion 411c. When the preforming elements 430 are moved laterally toward the first mold tool 410, the preforming elements 430 first contact the organo sheet 440 at the most projected portion of the first mold tool 410, that is to say the second flat portion 411c and, thus, firmly hold the organo sheet 440.

Then, the preforming elements 430 continue to move towards the first mold tool 410. As a result, the springs of the pins 436a of the preforming elements 430 begin to contract in the areas contacting the frontal surface 411 of the first mold tool 410 and the membrane 435 starts to become distorted to adapt oneself and match the shape of the first mold tool 410.

Accordingly, the preforming elements 430 push the organo sheet 440 and progressively drape it onto the frontal surface 411 of the first mold tool 410.

As shown in FIG. 6B, thanks to the recess provided initially between the first and second planes 437a, 438a of the preforming elements 430, the preforming elements 430 contact simultaneously the third and fourth flat portions 411e, 411g of the first mold tool 410 so that the draping remains progressive from the most projected portion of the first mold tool 410 towards its outer sides, which helps to reduce the appearance of defects such as wrinkles.

Then, as shown in FIG. 6C, the preforming elements continue to move towards the first mold tool 410 so as to complete the draping of the organo sheet 440 onto the first and fifth flat portions 411a, 411i of the first mold tool 410.

The remainder of the method is analogous to the first example.

Even if the present invention has been described with regard to particular exemplary embodiments, it is clear that these examples may be modified without departing from the scope of the invention as defined by the claims. Particularly, individual features of different presented embodiments can be combined in additional embodiments. As a result, the description and the drawings shall be considered in an illustrative way rather than a limitative way.

It is also clear that all the features described with reference to a method are transposable, individually or in combination, to a device, and vice versa.

1. A molding apparatus, comprising
a mold including a first mold tool and a second mold tool configured to face each other and to move in relation to each other so as to define a gap between them for molding therein a part comprising an overmolded sheet, and
at least one preforming element, distinct from the second mold tool, having a shape, or being configured to take a shape, complementary to that of a portion of the first mold tool, and configured to preform sheet onto the portion of the first mold tool.

2. The molding apparatus of claim 1, wherein the frontal surface of the at least one preforming element is inferior to 20% of the frontal surface of the first mold tool.

3. The molding apparatus of claim 1, wherein the at least one preforming element is plate-shaped, a length of the at least one preforming element being at least five times greater than its width.

4. The molding apparatus of claim 1, wherein the at least one preforming element extends continuously from one end of the first mold tool to an opposite end of the first mold tool.

5. The molding apparatus of claim 1, comprising a plurality of preforming elements, all preforming elements of the plurality of preforming elements extending in parallel along a longitudinal direction of the first mold tool at different levels in a width direction of the first mold tool.

6. The molding apparatus of claim 1, wherein the at least one preforming element comprises a low heat-conductive material or is provided with a low heat-conductive coating.

7. The molding apparatus of claim 1, wherein the at least one preforming element comprises a low sticking material or is provided with a low sticking coating.

8. The molding apparatus of claim 1, wherein the at least one preforming element comprises a plurality of segments movable in relation to each other.

9. The molding apparatus of claim 1, wherein the frontal surface of the at least one preforming element is configured to self-adapt to the shape of the first mold tool.

10. The molding apparatus of claim 9, wherein the at least one preforming element comprises a flexible frontal surface and a forming device configured to cause the frontal surface to take a predetermined shape.

11. The molding apparatus of claim 10, wherein the forming device comprises a plurality of spring-loaded or actuated pins.

12. The molding apparatus of claim 9, wherein the at least one preforming element comprises an elastic material.

13. The molding apparatus of claim 9, wherein an at-rest shape of the frontal surface of the at least one preforming element is non-uniform.

14. The molding apparatus of claim 1, wherein the at least one preforming element is retractable so as to allow the closing of the mold.

15. A molding method, comprising the steps of:
providing a mold including a first mold tool and a second mold tool configured to face each other and to move in relation to each other;
placing a sheet onto the first mold tool;
preforming the sheet by using a preforming element to push the sheet against a portion of the first mold tool, while the preforming element matches the shape of the portion of the first mold tool;
maintaining the sheet on the first mold tool tool;
removing the preforming element;
closing the mold;
injecting a matrix into the mold;
solidifying the matrix.
